(19) United States
(12) Patent Application Publication
(10) Pub. No.: US 2020/0186992 A1
(43) Pub. Date: Jun. 11, 2020

(54) Technique for Remote SIM Provisioning

(71) Applicant: Telefonaktiebolaget LM Ericsson (publ), Stockholm (SE)

(72) Inventors: Maria Esther Bas Sanchez, Madrid (ES); Abu Shohel Ahmed, Espoo (FI); Antonio Alonso Alarcon, Madrid (ES)

(21) Appl. No.: 16/631,949

(22) PCT Filed: Dec. 19, 2017
(86) PCT No.: PCT/EP2017/083468

§ 371 Date: Jan. 17, 2020

(30) Foreign Application Priority Data
Jul. 20, 2017 (EP) 17382480.6

(51) Int. Cl. H04W 8/20; H04W 8/18

(52) U.S. Cl. CPC H04W 8/20; H04W 8/18

(57) ABSTRACT

A technique for operating an RSP node (100), which is configured for remote subscriber identity module, SIM, provisioning, RSP, and comprises or is connectable to an interface (502) for communication with an MNO node (200) of a mobile network operator, MNO, is described. As to a method aspect of the technique, a download order message from the MNO node (200) is received through the interface (502). The download order message includes data (604) for generating a SIM profile (602). The SIM profile (602) is generated in response to the download order message according to the data (604) received for generating the SIM profile (602). A result (606) of the SIM profile generation is sent through the interface (502) to the MNO node (200).

### TECHNICAL FIELD

The present disclosure generally relates to a technique for remote SIM provisioning (RSP). More specifically, and without limitation, methods and nodes are provided for RSP communication through an interface.

### BACKGROUND

Embedded SIM (eSIM) according to the Global System for Mobile Communications Association (GSMA) provides a mechanism for remote provisioning and management of subscriber identity module (SIM) profiles, which is generically referred to as remote SIM provisioning (RSP). RSP allows “over the air” provisioning of the SIM profile for an initial operator, and the subsequent change of the SIM profile from one operator to another. A radio device or cellular device (briefly: device), e.g. a consumer device or an embedded device for machine-to-machine (M2M) connections, queries a subscription manager discovery server (SM-DS) for the address of a subscription manager data preparation (SM-DP or SM-DP+) node, and downloads the SIM profile from the SM-DP+ node. Furthermore, one device may be provisioned with multiple SIM profiles.

The SM-DP+ node is responsible for the generation and the protection of resulting SIM profiles upon the input and request of the mobile network operator (MNO). It is also responsible for the delivery of a SIM profile within a bound profile package (BPP), making the BPP available for the secure delivery to the device.

A conventional SM-DP+ node manages a plurality of SIM profiles that are generated in advance of their usage for each MNO. Existing RSP procedures share the plurality of generated SIM profiles “offline”, i.e., in a batch that is exchanged between the SM-DP+ node and the MNO. The plurality of generated and not yet used SIM profiles is available in an inventory at the SM-DP+ node. When releasing a SIM profile for download to a device, the MNO triggers the SM-DP+ for RSP by referring to one of the previously generated SIM profiles. For example, the MNO specifies a profile type or an integrated circuit card identifier (ICCID), and the SM-DP+ node selects the corresponding SIM profile from its inventory.

The existing RSP procedures have the disadvantage that the batch of network resources associated with the previously generated and not yet provisioned SIM profiles is blocked and unused until all these SIM profiles are released for download to a device. Moreover, a device cannot be provided with a device-tailored and subscriber-tailored SIM profile, e.g., a certain international mobile subscriber identity (IMSI), network access credentials and a personal identification number (PIN), if the specific SIM profile is not available in the batch of previously generated SIM profiles. And even if such credentials would be available in the batch of previously generated SIM profiles, the MNO may not identify or search the batch for credentials, since such functionality can jeopardize the security of the network access.

Moreover, the existing GSMA specifications (e.g., the documents SGP.21 and SGP.22, Version 2.0) do not mandate or specify a way to provision shared data between the SM-DP+ node and networks of MNOs for specific SIM profiles. The existing GSMA specifications define an ES2+ interface for the profile download initiation procedure. However, the GSMA specifications do not specify as part of such procedure, how to share said SIM profile data. Rather, the existing profile download preparation implicitly assumes the afore-mentioned “offline” process to share a batch of available SIM profiles. The download order procedure through the ES2+ interface merely exchanges the ICCID both as input and output parameters, i.e., as the reference to the SIM profile data previously shared “offline”.

The use of such an “offline” process to establish shared profile data has several problems. A complex out-of-band process has to be established between the telecommunications network of each MNO and the SM-DP+ node for specifying the shared batch of available SIM profiles. This is usually performed by offline exchange of encrypted files. This process is similar to the existing physical SIM card provisioning process in that the process is static and time-consuming.

Furthermore, both the SM-DP+ node and the corresponding node of the MNO need to previously provision their respective back-end systems with the SIM profile data of the shared batch of available SIM profiles, which implies two disadvantages. Firstly, some of the valuable resources of the MNO such as IMSI are allocated beforehand and reduce their usage time. Particularly, the reusability of the IMSI is limited.

Secondly, the system cannot react to a dynamic need of SIM profile provisioning as the sharing of SIM profiles between SM-DP+ node and MNO node underlies RSP but is performed independently in another process.

### SUMMARY

Accordingly, there is a need for an RSP technique that uses MNO resources more efficiently. Alternatively or in addition, there is a need for an RSP technique that allows provisioning subscriber-tailored SIM profiles. Alternatively or in addition, there is a need for an RSP technique that integrates data sharing and RSP.

As to one aspect, a method of operating an RSP node is provided. The RSP node is configured for remote subscriber identity module (SIM) provisioning (RSP). The RSP node comprises or is connectable to an interface for communication with an MNO node of a mobile network operator (MNO). The method comprises or triggers a step of receiving a download order message from the MNO node through the interface. The download order message includes data for generating a SIM profile. The method further comprises or triggers a step of generating the SIM profile in response to the download order message according to the data received for generating the SIM profile. The method still further comprises or triggers a step of sending a result of the SIM profile generation through the interface to the MNO node.

Alternatively or in addition, the one aspect relates to a method of operating an RSP node. The RSP node is configured for remote subscriber identity module (SIM) provisioning (RSP). The RSP node comprises or is connectable to an interface for communication with an MNO node of a mobile network operator (MNO). The method comprises or triggers a step of receiving a download order message from the MNO node through the interface. The method further comprises or triggers a step of generating a SIM profile in response to the download order message based on data for generating the SIM profile determined by the RSP node. The method still further comprises or triggers a step of sending a result of the SIM profile generation through the interface to the MNO node.

As to another aspect, a method of operating an MNO node of a mobile network operator (MNO) is provided. The MNO node is configured to trigger remote subscriber identity module (SIM) provisioning (RSP). The MNO node comprises or is connectable to an interface for communication with an RSP node configured for RSP. The method comprises or triggers a step of sending a download order message to the RSP node through the interface. The download order message includes data for generating a SIM profile. The method further comprises or triggers a step of receiving, through the interface from the RSP node, a result on the SIM profile generated in response to the download order message according to the data sent for generating the SIM profile. The method still further comprises or triggers a step of provisioning, based on the received result of the SIM profile generation, at least one of a telecommunications network of the MNO and a device radio-connectable with the telecommunications network.

Alternatively or in addition, the other aspect relates to a method of operating an MNO node of a mobile network operator (MNO). The MNO node is configured to trigger remote subscriber identity module (SIM) provisioning (RSP). The MNO node comprises or is connectable to an interface for communication with an RSP node configured for RSP. The method comprises or triggers a step of sending a download order message to the RSP node through the interface. The method further comprises or triggers a step of receiving, through the interface from the RSP node, a result on the SIM profile generated in response to the download order message based on data for generating the SIM profile determined by the RSP node. The method still further comprises or triggers a step of provisioning, based on the received result of the SIM profile generation, at least one of a telecommunications network of the MNO and a device radio-connectable with the telecommunications network.

The other method aspect may further comprise any feature and any step disclosed herein in the context of the one method aspect.

As to a further aspect, a computer program product is provided. The computer program product comprises program code portions for performing any one of the steps of the method aspects disclosed herein when the computer program product is executed by one or more computing devices. The computer program product may be stored on a computer-readable recording medium. The computer program product may also be provided for download via a data network, e.g., via the telecommunications network of the MNO and/or via the Internet. Alternatively or in addition, the method may be encoded in a Field-Programmable Gate Array (FPGA) and/or an Application-Specific Integrated Circuit (ASIC), or the functionality may be provided for download by means of a hardware description language.

As to a still further aspect, an RSP node is provided. The RSP node is configured for remote subscriber identity module (SIM) provisioning (RSP). The RSP node comprises or is connectable to an interface for communication with an MNO node of a mobile network operator (MNO). The RSP node is configured to perform the one method aspect. Alternatively or in addition the RSP node may comprise a receiving unit configured to receive a download order message from the MNO node through the interface. The download order message may include data for generating a SIM profile. The RSP node may further comprise a generating unit configured to generate the SIM profile in response to the download order message according to the data received for generating the SIM profile. The RSP node may still further comprise a sending unit configured to send a result of the SIM profile generation through the interface to the MNO node.

As to a still further aspect, an MNO node of a mobile network operator (MNO) is provided. The MNO node is configured to trigger remote subscriber identity module (SIM) provisioning (RSP). The MNO node comprises or is connectable to an interface for communication with an RSP node configured for RSP. The MNO node is configured to perform the other method aspect. Alternatively or in addition, the MNO node comprises a sending unit configure to send a download order message to the RSP node through the interface. The download order message may include data for generating a SIM profile. The MNO node further comprises a receiving unit configured to receive, through the interface from the RSP node, a result on the SIM profile generated in response to the download order message according to the data sent for generating the SIM profile. The MNO node still further comprises a provisioning unit configured to provision, based on the received result of the SIM profile generation, at least one of a telecommunications network of the MNO and a device radio-connectable with the telecommunications network.

As to a still further aspect, an RSP node for remote subscriber identity module (SIM) provisioning (RSP) is provided. The RSP comprises or is connectable to an interface for communication with an MNO node of a mobile network operator (MNO). The RSP node comprises at least one processor and a memory. Said memory comprises instructions executable by said at least one processor, whereby the RSP node is operative to receive a download order message from the MNO node through the interface. The download order message includes data for generating a SIM profile. Thereby, the RSP node is further operative to generate the SIM profile in response to the download order message according to the data received for generating the SIM profile. Thereby, the RSP node is further operative to send a result of the SIM profile generation through the interface to the MNO node.

As to a still further aspect, an MNO node of a mobile network operator (MNO) for triggering remote subscriber identity module (SIM) provisioning (RSP) is provided. The MNO node comprises or is connectable to an interface for communication with an RSP node configured for RSP. The MNO node comprises at least one processor and a memory. Said memory comprises instructions executable by said at least one processor, whereby the MNO node is operative to send a download order message to the RSP node through the interface. The download order message includes data for generating a SIM profile. Thereby, the MNO node is further operative to receive, through the interface from the RSP node, a result on the SIM profile generated in response to the download order message according to the data sent for generating the SIM profile. Thereby, the MNO node is still further operative to provision, based on the received result of the SIM profile generation, at least one of a telecommunications network of the MNO and a device radio-connectable with the telecommunications network.

As to a still further aspect, an RSP node for remote subscriber identity module (SIM) provisioning (RSP) is provided. The RSP node comprises or is connectable to an interface for communication with an MNO node of a mobile network operator (MNO). The RSP node comprises a reception module for receiving a download order message from the MNO node through the interface, the download order message including data for generating a SIM profile. The RSP node further comprises a generation module for generating the SIM profile in response to the download order message according to the data received for generating the SIM profile. The RSP node still further comprises a send module for sending a result of the SIM profile generation through the interface to the MNO node.

As to a still further aspect, an MNO node of a mobile network operator (MNO) for triggering remote subscriber identity module (SIM) provisioning (RSP) is provided. The MNO node comprises or is connectable to an interface for communication with an RSP node configured for RSP. The MNO node comprises a send module for sending a download order message to the RSP node through the interface, the download order message including data for generating a SIM profile. The MNO node further comprises a reception module for receiving, through the interface from the RSP node, a result on the SIM profile generated in response to the download order message according to the data sent for generating the SIM profile. The MNO node still further comprises a provision module for provisioning, based on the received result of the SIM profile generation, at least one of a telecommunications network of the MNO and a device radio-connectable with the telecommunications network.

Any of the nodes may further include any feature disclosed in the context of the corresponding method aspect. Particularly, any one of the units and modules, or a dedicated unit or module, may be configured to perform or trigger one or more of the steps of any one of the method aspects.

### BRIEF DESCRIPTION OF THE DRAWINGS

Further details of embodiments of the technique are described with reference to the enclosed drawings, wherein:

FIG. 1 shows a schematic block diagram for an embodiment of an RSP node configured for remote subscriber identity module provisioning;

FIG. 2 shows a schematic block diagram for an embodiment of an MNO node configured to trigger remote subscriber identity module provisioning;

FIG. 3 shows a flowchart for a method of operating an RSP node, which is implementable by the node of FIG. 1;

FIG. 4 shows a flowchart for a method of operating an MNO node, which is implementable by the node of FIG. 2;

FIG. 5 shows a schematic block diagram for a system implementation including the RSP node and the MNO node in communication through an interface;

FIG. 6 shows a schematic block diagram for profile data shared between the RSP node and the MNO node in communication through the interface;

FIG. 7 schematically illustrates a first example of a signaling diagram for the RSP node and the MNO node in communication through the interface;

FIG. 8 schematically illustrates a schematic second example of a signaling diagram for the RSP node and the MNO node in communication through the interface;

FIG. 9 shows an exemplary state diagram of a SIM profile shared between the RSP node and the MNO node in communication through the interface;

FIG. 10 shows a schematic block diagram of an embodiment of the RSP node of FIG. 1;

FIG. 11 shows a schematic block diagram of an embodiment of the MNO node of FIG. 2; and

FIG. 12 shows a schematic block diagram for an implementation of the interface connecting the RSP node and the MNO node, which is implementable with any embodiment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a 5G New Radio (NR) implementation, it is readily apparent that the technique described herein may also be implemented in any other radio network, including 3GPP LTE or a successor thereof, Wireless Local Area Network (WLAN) according to the standard family IEEE 802.11, Bluetooth according to the Bluetooth Special Interest Group (SIG), particularly Bluetooth Low Energy and Bluetooth broadcasting, and/or ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

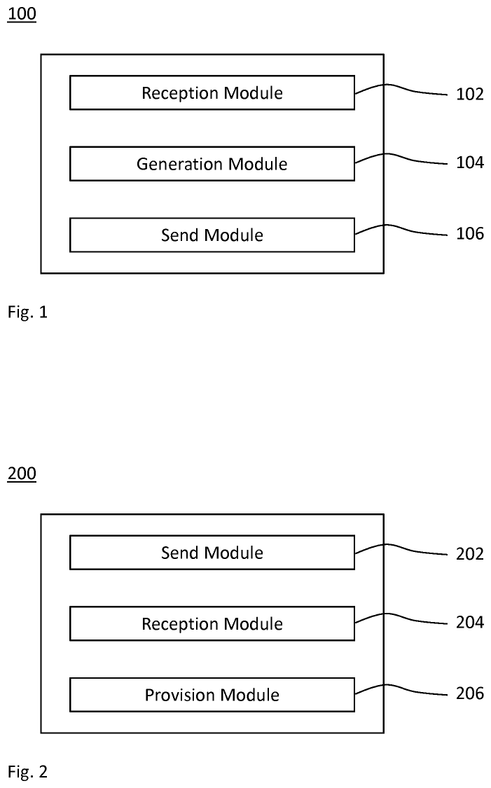

FIG. 1 schematically illustrates a block diagram for an embodiment of an RSP node, which is generically referred to by reference sign 100. The RSP node 100 is configured for remote subscriber identity module (SIM) provisioning (RSP).

The RSP node 100 comprises or is connectable to an interface for communication with an MNO node of a mobile network operator (MNO). The RSP node 100 further comprises a reception module 102 for receiving a download order message from the MNO node through the interface. The download order message includes data for generating a SIM profile. The RSP node 100 still further comprises a generation module 104 for generating the SIM profile in response to the download order message according to the data received for generating the SIM profile. The RSP node 100 still further comprises a send module 106 for sending a result of the SIM profile generation through the interface to the MNO node.

FIG. 2 schematically illustrates a block diagram for an embodiment of an MNO node, which is generically referred to by reference sign 200. The MNO node 200 is configured to trigger RSP. To this end, the MNO node 200 comprises or is connectable to an interface for communication with an RSP node configured for RSP. The MNO node 200 further comprises a sending module 202 for sending a download order message to the RSP node through the interface. The download order message includes data for generating a SIM profile. The MNO node 200 still further comprises a receiving module 204 for receiving, through the interface from the RSP node, a result on the SIM profile generated in response to the download order message according to the data sent for generating the SIM profile. The MNO node 200 still further comprises a provisioning module 206 for provisioning, based on the received result of the SIM profile generation, at least one of a telecommunications network of the MNO and a device radio-connectable with the telecommunications network.

Any one of the modules of the nodes 100 and 200 may be implemented by a unit configured to provide the corresponding functionality.

The MNO node connected with the RSP 100 through the interface may be an instance of the MNO node 200. The RSP node connected with the MNO 200 through the interface may be an instance of the RSP node 100.

The download order message may also be referred to as download order request. The sent result of the SIM profile generation may also be referred to as a download order response.

The technique can be specified and implemented as an extension of an RSP node, an MNO node and/or an interface between the RSP node and the MNO node based on an existing RSP technique. For example, embodiments of the technique are backward compatibility with GSMA SGP.21 and/or SGP.22, e.g., depending on an operating mode negotiated between the RSP node 100 and the MNO node 200, or if a trigger in the download order message is not set.

The MNO node 200 may be connected to and/or be part of a telecommunications network of the MNO. The telecommunications network of the MNO may include a radio access network (RAN) and/or a core network (CN) connected to the RAN.

The RAN of the MNO may include at least one base station. The RAN, e.g., each base station, may be configured to provide radio access to a radio device or cellular device, which is generically referred to as a “device”.

The telecommunications network, particularly the RAN, may be implemented according to the Global System for Mobile Communications (GSM), the Universal Mobile Telecommunications System (UMTS), Long Term Evolution (LTE) and/or New Radio (NR). A base station or a cell of the RAN may serve a plurality of such devices. Examples for the base station may include a 3G base station or Node B, 4G base station or eNodeB, a 5G base station or gNodeB, an access point (e.g., a Wi-Fi access point) and a network controller (e.g., according to Bluetooth, ZigBee or Z-Wave).

The RSP node 100 may be configured to provision the generated SIM profile to such a device. The device may be configured to use the radio access for machine-to-machine (M2M) communication. Alternatively or in addition, the device may be a consumer device.

The device may be configured for peer-to-peer communication (e.g., on a sidelink with another instance of such a device) and/or for accessing the RAN (e.g., in an uplink and/or a downlink). The device may be a user equipment (UE, e.g., a 3GPP UE), a mobile or portable station (STA, e.g. a Wi-Fi STA), a device for machine-type communication (MTC), an Internet of Thing (IoT) device or a combination thereof. Examples for the UE and the mobile station include a mobile phone, a tablet computer and a wearable device. Examples for the portable station include a laptop computer and a television set. Examples for the MTC device include robots, sensors and/or actuators, e.g., in manufacturing, automotive communication and home automation. The MTC device may be implemented in household appliances and consumer electronics. Examples for the combination include a self-driving vehicle, a door intercommunication system and an automated teller machine.

The technique may be implemented on a radio resource control (RRC) layer of a protocol stack for the radio communication and/or in a control plane of the CN.

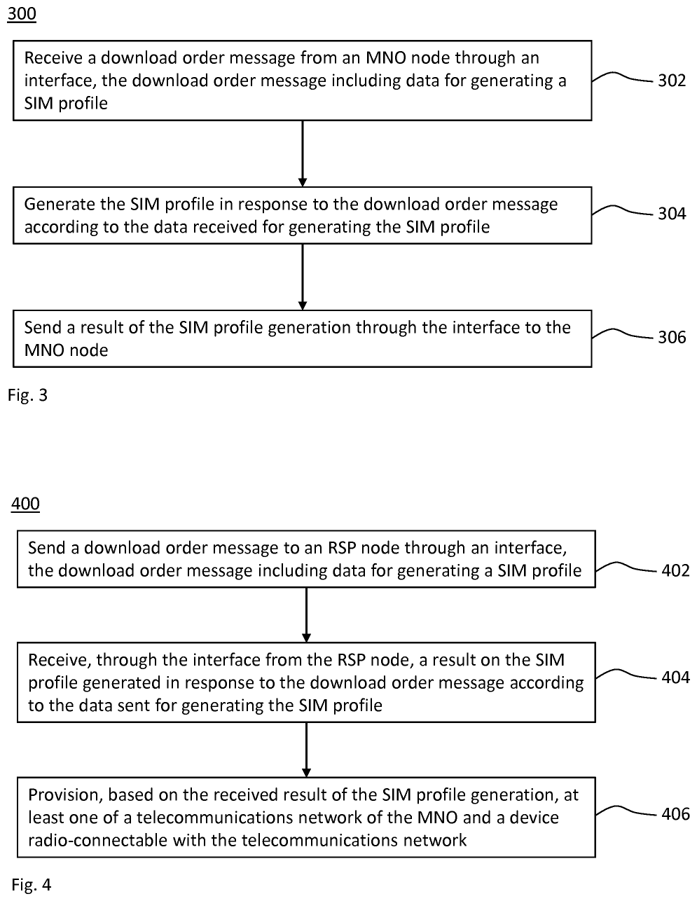

FIG. 3 shows a flowchart for a method 300 of operating an RSP node 100, which is configured for RSP and comprises or is connectable to an interface for communication with an MNO node 200 of an MNO. The method 300 comprises a step 302 of receiving a download order message from the MNO node 200 through the interface. The download order message includes data for generating a SIM profile. The SIM profile is generated in response to the download order message according to the data received for generating the SIM profile in a step 304. A result of the SIM profile generation is sent through the interface to the MNO node 200 in a step 306 of the method 300.

The RSP node 100 may perform the method 300. For example, the modules 102, 104 and 106 may perform the steps 302, 304 and 306, respectively.

FIG. 4 shows a flowchart for a method 400 of operating an MNO node 200 of an MNO, which is configured to trigger RSP and comprises or is connectable to an interface for communication with an RSP node configured for RSP. The method comprises a step 402 of sending a download order message to the RSP node through the interface. The download order message includes data for generating a SIM profile. In a step 404 of the method 400, a result on the SIM profile generated in response to the download order message according to the data sent for generating the SIM profile is received through the interface from the RSP node. Based on the received result of the SIM profile generation, at least one of a telecommunications network of the MNO and a device radio-connectable with the telecommunications network is provisioned in a step 406 of the method 400.

The method 400 may be performed by the MNO node 200. For example, the modules 202, 204 and 206 may perform the steps 402, 404 and 406, respectively.

Embodiments of the technique enable a telecommunications network of the MNO to readily serve a device (e.g., a device of a new subscriber or a device subject to a changed subscription) based on the SIM profile individually tailored for the device or the subscriber according to the data sent by the MNO node. The MNO node may be a node of the telecommunications network of the MNO.

Alternatively or in addition, devices of subscribers of the telecommunications network of the MNO may be enabled to acquire the SIM profiles “online”. E.g., the device to which the SIM profile is going to be downloaded triggers via the MNO node 200 the RSP of the SIM profile. The MNO node 200 may be enabled to order and/or release the SIM profile for the subscriber and its device “online”, i.e., as soon as the telecommunications network of the MNO has the need and/or the information (e.g., included in the data of the download order message) to serve the device of the subscriber based on the generated SIM profile.

By advancing usage and functionality of an existing interface, e.g., the ES2+ interface, between the RSP node 100 and the MNO node 200 according to the technique for sharing the data for generating the device-tailored and/or subscriber-tailored SIM profile, the SIM profile can be provisioned “online”, ad hoc, immediately and/or on demand.

Corresponding instances of the interface may be implemented at each of the RSP node 100 and the MNO node 200. The corresponding instances of the interface may be in a connected state with respect to each other. For example, a transport mechanism may be established and maintained through the interface (e.g., terminated by each instance of the interface). The transport mechanism may include at least one of a data link, a session, a tunnel and intermediate nodes between the RSP node 100 and the MNO node 200. The transport mechanism may use Transport Layer Security (TLS), particularly Hypertext Transfer Protocol Secure (HTTPS) or Session Initiation Protocol Secure (SIPS).

Herein, the term “interface” may refer to the instance of the interface implemented at either side of the nodes 100 and 200, e.g., in a protocol stack of a communication protocol implemented at each of the nodes 100 and 200. Alternatively or in addition, the term “interface” may encompass the transport mechanism (e.g., a session) established and maintained by means of the interface between the nodes 100 and 200.

Furthermore, by advancing an existing interface, the connected state of the interface (e.g., a session) connecting the RSP node 100 and the MNO node 200 may be established and maintained independently of a single SIM profile. For example, the interface may maintain a persistent session. Alternatively or in combination, the connected state of the interface (e.g., a session) connecting the RSP node 100 and the MNO node 200 may be established and maintained for exchanging other signaling (e.g., for administrative functions in the sense of SGP.22, Table 1, description for ES2+) and/or for sharing data for generating other SIM profiles. Moreover, maintaining the connected state of the interface (e.g., a session) connecting the RSP node 100 and the MNO node 200 can improve resource efficiency, since the same interface is used for both communication directions, namely for providing the data for generating the SIM profile from the MNO node to the RSP node 100 and for providing the SIM profile generation result (e.g., including complementary data and/or a confirmation) from the RSP node 100 to the MNO node 200.

The reception of the download order message through the interface may trigger the step of generating the SIM profile. The SIM profile may not be previously generated or prepared (e.g., at the RSP node). “Generating” the SIM profile may include preparing or building the SIM profile, e.g., such that all information to be provisioned to the device is gathered, combined and/or packed for the download.

A single SIM profile may be generated in response to the download order message according to the step 304. The data received in the step 302 may specify a single SIM profile, e.g., an individual, device-specific and/or subscriber-specific SIM profile.

The interface may comprise a sending interface for communication towards the telecommunications network of the MNO and a receiving interface for communication from the telecommunications network of the MNO. The interface between the RSP node and the MNO node may be a control interface or signaling interface. Alternatively or in addition, the MNO node may comprise a receiving MNO node for the communication towards the telecommunications network of the MNO and a sending MNO node for the communication from the telecommunications network of the MNO.

Hardware for providing functionality of a subscriber identity module (SIM) may be referred to as a universal integrated circuit card (UICC). The UICC may be embedded (eUICC, e.g., without the form factor of a card) in the device. The SIM profile may also be referred to as an embedded SIM (eSIM) profile.

The device may be configured for radio access to the telecommunications network of the MNO, particularly the RAN of the MNO. The RSP node 100 may provide the generated SIM profile for download to the device, e.g., via a local profile assistant (LPA).

The RSP node 100, the LPA and/or the eUICC may be configured for generating, changing and/or handling the SIM profile, e.g., according to the Global System for Mobile Communications (GSM) Association (GSMA), particularly according to the technical specification GSMA SGP.21, “RSP Architecture”, Version 2.0 and/or the technical specification GSMA SGP.22, “RSP Technical Specification”, Version 2.0. The eUICC may host multiple SIM profiles.

The RSP node may be any node configured for RSP. The RSP node may comprise the functionality of at least one of SM-DP+, SM-DS, ES11, ES12 and ES15, e.g., according to GSMA SGP.21 and/or GSMA SGP.22. The RSP node may also be referred to as an SM-DP+ node.

The interface may comprise the functionality of an ES2+ interface, e.g., according to GSMA SGP.21 and/or GSMA SGP.22, or may be backward compatible with the ES2+ interface. The RSP node 100 may be accessible by the MNO node 200 and further MNO nodes 200 (of the same MNO or further MNOs), e.g., through the same interface. The RSP node 100 may be outside of the telecommunications network of the MNO, e.g., outside of the RAN of the MNO.

The RSP node 100 may be accessible by the eUICC, e.g., through the LPA associated with or located at the eUICC and/or the device. The RSP node may be accessible for the eUICC independent of the MNO, i.e., independent of the RAN of the MNO, e.g., via an independent Wi-Fi connection of the device. For example, the LPA may utilize any on-device and existing connection to the Internet, such as Wi-Fi or Wi-Fi direct, in order to reach out to the RSP node 100. Over such connection, interfaces ES5+, ES8+ and/or ES9+ according to GSMA SGP.21 and/or GSMA SGP.22 may be established.

The data received in the download order message may be included in, or may be input to, the SIM profile generated in the step 304. The generated SIM profile may be indicative of the data in the download order message. Alternatively or in addition, the data, or a portion of the data, in the download order message may be input into the generated SIM profile using a non-invertible function, e.g., a cryptographic hash function.

The data included in the download order message may define the SIM profile. For example, the generated SIM profile may be solely based on or determined by the data received from the MNO in the download order message.

Alternatively, the data included in the download order message defines a first data portion of the SIM profile. The first data portion may tailor the SIM profile without completely determining the SIM profile.

The step 304 of generating the SIM profile may include complementing the received first data portion by a second data portion. The combination of the first data portion and the second data portion may define the SIM profile. The first data portion may be complemented by the second data portion at the RSP node. The RSP node may determine (e.g., provide and/or gather) the second data portion.

The first data portion and/or the second data portion (preferably, either the first data portion or the second data portion) may include an international mobile subscriber identity (IMSI). The IMSI may comply with the document 3GPP TS 23.003, “Numbering, addressing and identification”, Version 14.4.0.

The IMSI may be determined (e.g., selected) by the MNO node 200 or any other node associated with the MNO. The determined IMSI may be tailored for the subscriber or the device.

Alternatively, the IMSI may be selected by the RSP node 100, e.g., from a range of IMSIs. The range of IMSIs may be associated with the MNO node 200, the telecommunications network and/or the MNO from which the download order message has been received in the step 302.

The step 304 of generating the SIM profile may include combining, e.g., at the RSP node 100, the first data portion and the second data portion. The SIM profile may be defined by the first data portion and the second data portion only in combination. The combination of the first data portion and the second data portion may completely specify the SIM profile to be generated in the step 304.

The step 304 of generating the SIM profile may include selecting and/or generating the second data portion (briefly referred to as “data selection/generation”).

The sent result of the generating step 304 may include the second data portion. The RSP node 100 may send the result in the step 306 without sending first data portion.

At least one of the data received in the download order message, the first data portion and the second data portion may include at least one of configuration data for network provisioning, operator credentials and subscriber credentials. The subscriber credentials may include at least one of authentication credentials and cryptographic keys. The subscriber credentials may include at least one of an IMSI, a subscriber key (Ki, also referred to as subscriber authentication key), a personal identification number (PIN) and a personal unlocking key (PUK). At least some of the subscriber credentials (e.g., PUK and/or PIN) may be delivered to the subscriber by the MNO in the step 406, e.g., using the RAN of the MNO or any other access network such as Wi-Fi (e.g., at the first SIM profile download to the device).

Alternatively or in addition, the subscriber credentials (e.g., as defined by GSMA SGP.21, Section 1.4) may include at least one of network access credentials, Over-the-Air (OTA) keys for remote management of a file and/or an application and authentication algorithm parameters (which may also be referred to as algorithm parameters, algorithm data or algorithm personalization data). The OTA keys may be used in conjunction with OTA platforms.

The network provision may include registering the generated SIM profile (e.g., based on the IMSI) in at least one data base of the telecommunications network, e.g., the CN, of the MNO. The data base may include an authentication center (AuC), a home location register (HLR), e.g., according to GSM or the UMTS, or a home subscriber server (HSS), e.g., according to an evolved packet core (EPC). The MNO node 200 may include the data base or may be connected to the data base.

At least one of the data received in the download order message, the first data portion and the second data portion may include at least one of an IMSI, network access credentials, OTA keys, authentication algorithm parameters, a PIN and a PUK.

The network access credentials may include at least one of a subscriber (authentication) key (e.g., referred to by the symbol Ki or K) and the IMSI. The authentication key may further be encrypted (e.g., referred to by the symbol eKi or eK, respectively) in the steps 302, 306, 402 and/or 404. The authentication key may include an individual subscriber authentication key. The authentication key may be a secret key shared between the device and the MNO node 200 or the telecommunications network of the MNO (e.g., the HLR of the home network of the subscriber). A length of the authentication key may be 128 bit.

At least one of the data in the download order message, the first data portion and the second data portion exchanged between the RSP node 100 and the MNO node 200 through the interface may be encrypted using a symmetric key previously shared between the RSP node 100 and the MNO node 200. Any piece (e.g., any bit field) of the data in the download order message, of the first data portion and/or of the second data portion may be exchanged through the interface in encrypted form.

The symmetric key may be generated by the RSP node 100 and/or the MNO node 200. For example, the symmetric key may be generated using the 3GPP confidentiality and integrity algorithms F8 or F9, also referred to as KASUMI (e.g., according to the documents 3GPP TS 35.201, Version 14.0.0 and 3GPP TS 35.202, Version 14.0.0), using the 3GPP authentication and key generation functions, also referred to as MILENAGE (e.g., according to the document 3GPP TS 35.206, Version 14.0.0), and/or using algorithms for GSM or Enhanced Data Rates for GSM Evolution (EDGE) such as the A5/2 encryption algorithms or for General Packet Radio Service (GPRS) such as the GEA3 encryption algorithm (e.g., according to the document 3GPP TS 55.216, Version 6.2.0).

A plurality of symmetric keys may be previously shared between the RSP node 100 and the MNO node 200. The data exchange (e.g., the first data portion in the steps 302 and 402 and/or the second data portion in the steps 306 and 404) between the RSP node 100 and the MNO node 200 through the interface may further include an indicator referring to one of the shared symmetric keys. A different one of the shared symmetric keys may be used (e.g., each time) when generating different SIM profiles.

Optionally, the data received in the download order message does not include a reference to a set of data that is available at the RSP node 100, defines the SIM profile and/or is not yet released for download to a device. Such a set of data, or a plurality of such data sets, may be referred to as an inventory. The inventory may be stored or may be accessible at the RSP node 100. The inventory may include a plurality of SIM profiles, e.g., SIM profiles predefined, shared and/or generated prior to and/or independent of receiving the download order message. Alternatively or in addition, if such reference is included in the download order message in the step 302, the reference may be ignored, or may be interpreted not as a reference to the inventory, in the step 304 of generating the SIM profile at the RSP node. For example, a predefined value of the reference (e.g., zero, a null pointer or nil pointer) may trigger the SIM profile generation.

In one implementation of the technique, the download order message does not refer to a previously generated SIM profile, e.g., in the inventory. For example, the data included in the download order message may not include an integrated circuit card identifier (ICCID). In same or another implementation, the RSP node 100 may ignore the reference or may interpret the reference not as an index to the inventory if such reference is included in the download order message. For example, the reception 302 of the download order message and/or the data in the download order message may trigger the SIM profile generation 304. The reference, e.g., the ICCID, may be an input parameter to the SIM profile generation (e.g., in the one or the other implementation).

Upon sending the result of the SIM profile generation in the step 306, the SIM profile is optionally not in an available state and/or stored in the inventory at the RSP node. The step of generating the SIM profile may be independent of the inventory. The RSP node may, e.g., not maintain an inventory.

The download order message may include a trigger for the technique or at least the step 304. The SIM profile may be selectively generated in response to the download order message according to the data if (e.g., only if) the trigger is set. If the trigger is set, the profile may be generated based on the received data (e.g., the first data portion) and data determined (e.g., generated or obtained) at the RSP node (e.g., the second data portion). Furthermore, if the trigger is set, any received reference to an inventory may be ignored for generating the SIM profile. The reference (e.g., ignored in the step 304 of SIM profile generation) may be included in the sent result, e.g. in a download order response message. In other words, the reference received as data in the download order message in the step 302 might not be considered for the generation step 304 and may be considered for sending back the second data portion as a response to the download order message in the step 306.

The trigger may be set if a trigger bit is set (e.g., equal to 1 or one). If the trigger is not set (e.g., if the trigger bit is equal to 0 or zero), a SIM profile may be provided based on the inventory at the RSP node and/or according to a reference in the download order message, e.g., according to the technical specification GSMA SGP.21, “RSP Architecture”, Version 2.0 and/or the technical specification GSMA SGP.22, “RSP Technical Specification”, Version 2.0. The technique may be backward compatible by not setting the trigger.

The step 304 of generating the SIM profile may include providing the SIM profile for download. The RSP may include providing the SIM profile for download to the device.

Upon sending the result of the SIM profile generation, the generated SIM profile may be in at least one of an allocated state, a linked state, a confirmed state and a released state. The step 304 of generating the SIM profile may include building the SIM profile and/or storing the SIM profile for download. The RSP node 100 may readily provide the generated SIM profile for download, e.g., in the released state. The LPA may be enabled to start the download of the generated SIM profile as soon as the subscriber credentials are delivered by the MNO (e.g., delivered over the telecommunications network of the MNO, e.g., by sending the subscriber credentials to the device).

The step 304 of generating the SIM profile may include building a protected profile package (PPP) including the SIM profile. More specifically, the step 304 of generating the SIM profile may include at least one of: preparing a profile package including the SIM profile, securing the profile package with a profile protection key, storing the profile protection key in a secure manner as well as the protected profile package (PPP) in a profile package repository and/or linking the PPP to a specified eUICC identifier (eID or EID).

The method may further comprise at least one of a step of binding the PPP to the respective eID and a step of securely downloading the bound profile packages to the LPA of the respective eUICC and/or device.

The step 306 of sending the result of the generation may include sharing the generated SIM profile with the MNO node 200. The RSP node 100 may include functionality for Subscription Manager Data Preparation (SM-DP) or a successor thereof. The RSP node 100 may provide SM-DP functionality, SM-DP+ functionality (e.g., according to the technical specification GSMA SGP.21, “RSP Architecture”, Version 2.0 and/or the technical specification GSMA SGP.22, “RSP Technical Specification”, Version 2.0.) or functionality of a successor thereof.

The interface for the communication between the RSP node 100 and the MNO node 200 may include an ES2 interface or a successor thereof. The interface may be an ES2+ interface (e.g., according to the technical specification GSMA SGP.21, “RSP Architecture”, Version 2.0 and/or the technical specification GSMA SGP.22, “RSP Technical Specification”, Version 2.0.) or a successor thereof (e.g., referred to as ES2++). The technical specification GSMA SGP.21 may define an architectural approach, and the technical specification GSMA SGP.22 may define a related technical specification for RSP, e.g., targeting the consumer devices. The technical specification GSMA SGP.21 defines a mechanism for “over the air” RSP of consumer devices with the necessary credentials to gain mobile network access, e.g., under the assumption that the same or similar authentication protocols as in hard-wired SIM profiles is used.

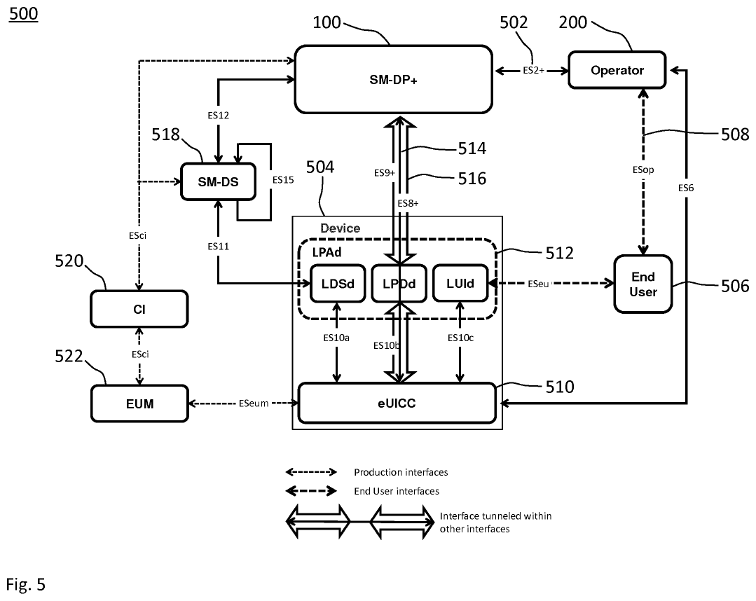

FIG. 5 shows a schematic block diagram for an example architecture 500 of a GSMA implementation of the RSP technique. The technique is implemented as an extension of the technical specification GSMA SGP.22, Version 2.0.

The RSP node 100 and the MNO node 200 are connected through an ES2+ interface 502 that is functionally extended according to the technique (which may thus be referred to by ES2++). For backward compatibility, the functionality of the interface 502 may also enables the MNO 200 to order conventional SIM profiles out of the inventory for eUICCs as well as other administrative functions.

After the step 306, the method 300 may further comprise a step of provisioning the generated SIM profile to the device 504, e.g. a consumer device. The SIM profile is downloaded by the LPA 512 at the device 504 by means of secure transport of the BPP through an ES9+ interface 516. An ES8+ interface 514 provides a secure end-to-end channel between the SM-DP+ node 100 and the eUICC 510 for the administration of the ISD-P and the associated SIM profile during download and installation.

The roles of some nodes and interfaces in the architecture 500, which may be relevant for implementing the technique, are described. This description of nodes may be replaced or completed by the technical specification GSMA SGP.21, Version 2.0. For brevity, only roles and interfaces of the architecture 500 referred to below for implementing the technique are described herein.

The RSP node 100 comprises at least the functionality of a Subscription Manager Data Preparation node, e.g., the SM-DP+ node 100, which is responsible for the creation, generation, management and the protection of resulting SIM profiles upon the input and/or request of the MNO node 200 (which may also be referred to as the MNO or the Operator). The SM-DP+ node 100 is also responsible for the delivery of a SIM profile within a Bound Profile Package (BPP), making the BPP available for the secure delivery. In addition, the SM-DP+ node 100 is responsible for requesting the creation of an Issuer Security Domain Profile (ISD-P) in an eUICC 510 at the device 504, into which the Profile will be installed. After installation of the SIM profile, the SM-DP+ node 100 is the off-card entity that is responsible for the lifecycle management of the ISD-P that was created at its request.

In the step 304, the SIM profile is created by the SM-DP+ node 100. According to the step 302, the SM-DP+ node 100 takes as input the data provided by the MNO 200 for generating the SIM profile as the first data portion. The first data portion includes IMSI, OTA keys and/or algorithm data. The technique may be implemented as a process of input data acquisition from the MNO according to the step 302. The second data portion may be MNO-specific data that is the same for each SIM profile individually generated for the same MNO 200.

Each generated SIM profile may represent the functionality of a conventional hard-wired UICC. Before the SIM profile is individually generated in the step 304 and can be download by an end user 506 to the device 504 of the end user 506, a profile download initiation may include the end user signing a contract with the MNO.

The end user 506 may initiate the download initiation procedure. The procedure can be triggered from the device (e.g. a eUICC phone) as the primary device that subsequently downloads the SIM profile, from any other device (e.g. any PC accessible by the end user 506), through a customer agent of the MNO and/or any other convenient means provided by the MNO (e.g. a web user interface).

The download initiation procedure may comprise at least one of the following sub-processes: (A) a contract subscription process, (B) a download preparation process, (C) a contract finalization process, and (D) an optional subscription activation process.

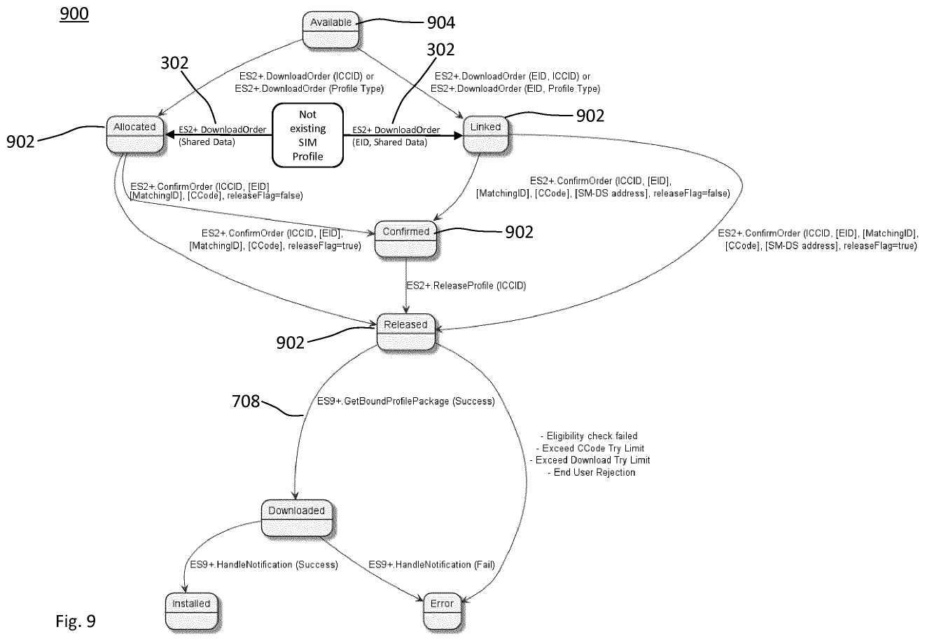

A conventional process for profile download initiation, which may be extended by the subject technique, is described in the technical specification GSMA SGP.22, Version 2, in Chapter 3.1.1 and FIG. 9 therein.

In the sub-process (A) for the contract subscription process between the end user and the MNO, a contract is selected. The sub-process (A) shall happen prior to the profile download and installation procedure. During the execution of the sub-process (A), the MNO node 200 may acquire technical information, e.g., including the eID and an International Mobile Equipment Identity (IMEI) of the device 510. Optionally, related device capabilities is acquired by the MNO node 200, e.g. based on a Type Allocation Code (TAC) comprised in the IMEI. Optionally, the acquired information may comprise contract details, user details, payment details etc.

The first data portion in the download order message of the steps 302 and 402 may include, or may be based on, at least some of the technical information acquired by the MNO node 200. The MNO node 200 may acquire the technical information from the end user though a user interface 508, which may include an application executed on the device independently from the eUICC 510.

The sub-process (B) for download preparation includes the steps 302 and 402 using the ES2+ interface 502 between the SM-DP+ node 100 and the MNO node 200. In the sub-process (B), the MNO node 200 asks the SM-DP+ node 100 to create and allocate a SIM profile according to the first data portion. Once the MNO node 200 has performed certain action, for example, triggered provisioning the associated telecommunications network, the MNO node 200 uses the ES2+ interface 502 to confirm the generated SIM profile that has been reported by the SM-DP+ node 100 to the MNO node 200 according to the steps 306 and 404. Subsequently, the SIM profile can be downloaded from the SM-DP+ node 100 by the end user 506 to the associated device 510.

The first data portion included as the data in the download order message is needed by the SM-DP+ node 100 to create and/or allocate the generated SIM profile. The first data portion is also referred to as the SIM profile specification. The first data portion is established with the MNO node 200 previous to ES2+ procedures.

While the download order message exchanged through the ES2+ interface 502 may contain the ICCID both as input of the procedure in the steps 302 and 402 as well as output of the procedure in the steps 306 and 404, the ICCID is expendable at least in its function as the reference to an inventory. Rather, the first data portion comprises the data for generating the SIM profile expressly, e.g., to the extent the MNO node specifies the individual, user-tailored SIM profile. For example, the first data portion may comprise at least one of the IMSI, the PIN, the PUK, the key Ki and algorithm personalization data.

The IMSI is chosen from an IMSI series assigned to the MNO. The key Ki is usually generated using a cryptographically secure random-number generator. This diminishes the possibility of random number collusion or easy guessing by an attacker. The key Ki is generated on the fly (i.e., without earlier storage). E.g., the key Ki is generated at the same time at least one of the OTA keys, the PIN and the PUK are generated or at the same time the rest of the first data portion is generated. The key Ki is never stored in and/or exchanged by the SM-DP+ node 100 or the MNO node 200 without being encrypted. The PIN and the PUK are random numbers generated during the profile generation 304.

In the sub-process (C) for contract finalization, the MNO provisions the end user with relevant information necessary for downloading the generated SIM profile according to the step 406. The information provisioned to the end user, e.g., to the device independently of the eUICC embedded in the device may include an activation code (AC) with a Matching-ID and/or an SM-DP+ address of the SM-DP+ node 100.

The sub-process (D) for subscription activation is optional. It is most likely that the MNO backend provisioning (e.g., provisioning the telecommunications network of the MNO according to the step 406) can be performed during the download preparation process. If MNO backend provisioning cannot be performed, the subscription activation process can be performed as a separate process to decouple the download preparation processes (A) and/or (B) from the contract finalization sub-process (C).

Once the end user 506 has concluded contract subscription procedure (A) with the MNO as well as MNO backend provisioning (C) has been completed, the end user 506, e.g., by means of the device 504, downloads the individually generated SIM profile from the SM-DP+ node 100 to the local device 504, which may be put into normal operation.

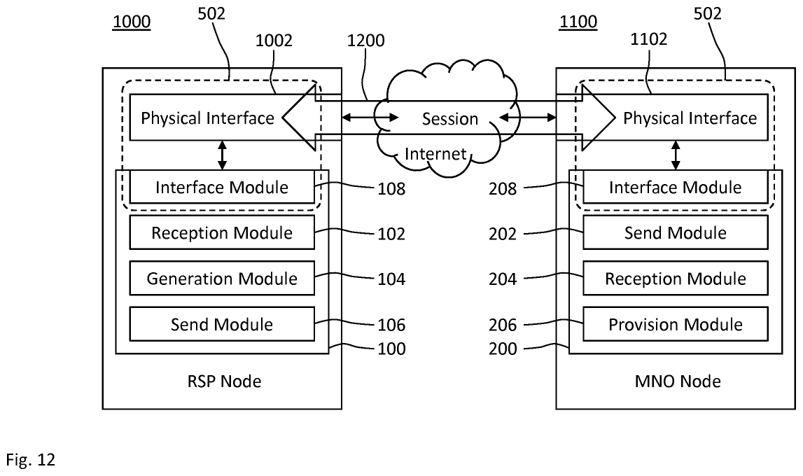

The technical specification GSMA SGP.22, Version 2, describes in Chapter 3.1.3, and FIG. 11 therein, download and installation procedures for a GSMA implementation of the SIM profile. The device 504 is first authenticated following a public key infrastructure (PKI) procedure. Then, a SIM profile is requested to the SM-DP+ node 100 according to the step 302. The SM-DP+ node 100 generates the SIM profile specifically according to the first data portion, protects the generated SIM profile and bounds it using secure encryption methods. The protected SIM profile is downloaded to the device 504. Only the eUICC 510 for which the SIM profile was created, is able to decrypt and install the SIM profile, e.g., according to the technical specification GSMA SGP.22, Version 2, Chapter 3.1.3.

While the RSP node 100 comprises at least the functionality of the SM-DP+ node, the RSP node 100 may further comprise or be supported by an SM-DS server 518 as an access point for the eUICC 510 in order to find events from the SM-DP+ node.

The PKI procedure may involve a certificate issuer 520 authorized to issue digital certificates. Optionally, the RSP node 100 and/or the MNO node 200 determine capabilities of the eUICC 510 for which the SIM profile is tailored based on information contained in the eID itself, additional tables locally handled by the MNO node 200 or in communication with an external entity, e.g., an eUICC Manufacturer (EUM) 522 of the eUICC 510.

The data exchanged through the interface 502, from the MNO node 200 to the RSP node 100 and vice versa, may be collectively referred to as shared data. The shared data may also be referred to as shared profile data. The shared data 600 may specify, e.g., completely, the individual SIM profile 602 generated in the step 304.

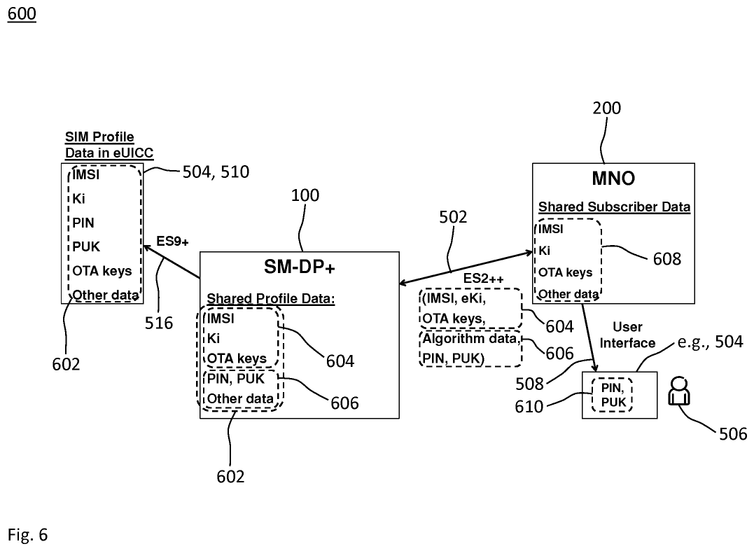

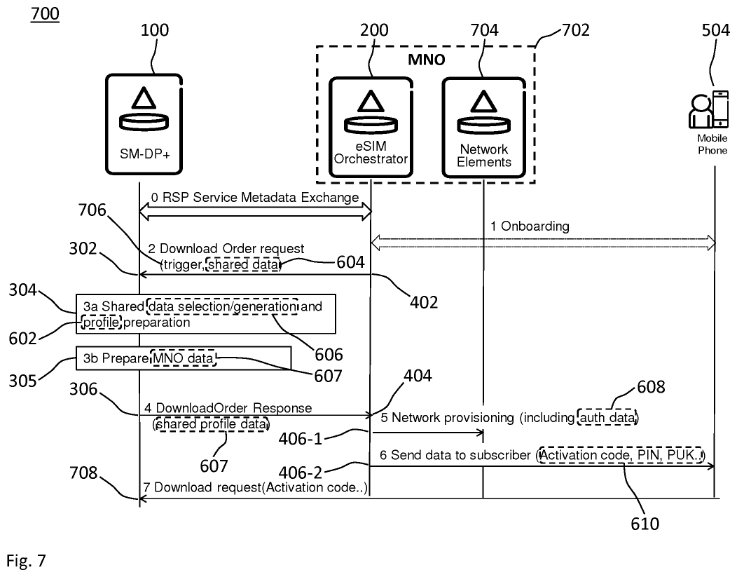

FIG. 6 schematically illustrates the shared data 600 for the RSP. The data is shared, e.g., in different data portions, among the eUICC 510 (e.g., embedded in the device 504), the SM-DP+ node as the RSP node 100, the MNO node 200 (more specifically, the telecommunications network of the MNO) and the end user 506 (e.g., via a dedicated channel 508 or general push service received by a client application executed by the device 504).

At least in some embodiments, the shared data 600 may include data used for the RSP, which is referred to as RSP data. The RSP data is used for the generation 304 of the SIM profile 602 and/or included in the SIM profile 602. Thus, the RSP data is also referred to as the “SIM profile” 602.

The data provided in the steps 302 and 402 from the MNO node 200 to the RSP node 100 may include the SIM profile 602. I.e., all data required for generating the SIM profile 602 in the step 304 may be determined at the MNO (e.g., collected at the MNO node 200) and included in the download order message. The steps 306 and 404 may provide, from the RSP node 100 to the MNO node 200, a confirmation message or an error message, which is, e.g., indicative of whether or not the SIM profile 602 has been successfully released.

Alternatively, as schematically illustrated in FIG. 6, the shared data 600 includes, in the communication direction from the MNO node 200 to the RSP node 100, a first data portion 604 of the SIM profile 602. The first data portion 604 may be a proper subset of the data set defining the SIM profile 602, i.e., of the data necessary for SIM profile generation in the step 304. The RSP node 100 complements the first data portion 604 by a second data portion 606. In other word, the RSP node 100 determines the second data portion 606 to complete the SIM profile 602, e.g., in the step 302 and/or 304.

The first data portion 604 and the second data portion 606 may be mutually exclusive. Furthermore, the first data portion 604 and the second data portion 606 may be complementary relative to the SIM profile 602.

In same or further embodiments, the shared data 600 may include data for network provisioning (e.g., network configuration), which is referred to as MNO data 608. The MNO data 608 is used at the MNO (e.g., by the MNO node 200 or the CN of the MNO) to configure the telecommunications network. In same or further embodiments, the shared data may include data for end user delivery, which is referred to as user data 610.

The MNO data 608 may be a subset of the SIM profile 602. The user data 610 may be a subset of the SIM profile 602. The MNO data 608 and the user data 610 may be mutually exclusive.

The SIM profile 602 may include at least one of: IMSI, Ki, algorithm data, PIN and PUK. The MNO data 608 and the user data 610 may include at least one of: IMSI, Ki, algorithm data, PIN and PUK. The MNO data 608 may include at least one of: IMSI, Ki and algorithm data. The user data 610 may include at least one of: PIN and PUK.

Both the MNO data 608 and the user data 610 are required for both generating the SIM profile 602 (i.e., so that the SIM profile 602 can be generated for a particular eUICC) and to dynamically provision the telecommunications network (e.g., provisioning and activation of a particular SIM profile).

Thus, the methods 300 and 400 can enable the RSP node 100 and the MNO node 200 to exchange shared profile data (i.e., IMSI, keys and algorithm data, PIN, PUK, etc.). The technique can be flexibly implemented, e.g., it can be agreed between the MNO node 200 and the SM-DP+ node 100 which entity generates which portions of the data and sends it to the respective other entity.

In a first implementation, the SM-DP+ node 100 generates the shared profile data, i.e., the SIM profile 602. In the step 302, a profile generation request (e.g., an ES2+ DownloadOrder with input data, which may also be referred to as profile preparation request) as the download order message is received at the SM-DP+ node 100. For example, the data included in the download order message comprises the set trigger for the individual SIM profile generation. The SM-DP+ node 100 generates according to the step 304 the corresponding SIM profile and store it prepared for the download for the end user 506, i.e., to the device 504.

More specifically, the SM-DP+ node 100 chooses an IMSI and algorithm personalization data. The SM-DP+ node 100 generates Ki, PIN, PUK or other needed data, e.g., using any one of the afore-mentioned cryptographic functions. The IMSI is chosen, for example, from an IMSI series provided by the MNO (particularly, the MNO node 200) as part of a previous initiation process.

In the step 306, the SM-DP+ node 100 sends a profile generation response (e.g., an ES2+ DownloadOrder with its output data) as the result of the SIM profile generation including the generated profile data 602 (e.g., IMSI, algorithm data, Ki, PIN, PUK, etc.) to the MNO node 200.

In the step 404, upon receiving the profile data as the result of the SIM profile generation from the SM-DP+ node 100, the MNO node 200 provisions the subscriber data in the telecommunications network (e.g., to at least one of the nodes HSS, AUC, AS, etc.). Furthermore, the MNO node 200 provisions its subscriber 506, e.g., through the ESop interface 508, with PIN and PUK according to the step 406.

In a second implementation, the MNO node 200 generates the shared profile data, i.e., the SIM profile 602. The MNO node 200 generates the shared profile data (e.g., IMSI, Ki, algorithm data, PIN, PUK, etc.), e.g., in a substep of the step 402. Furthermore, the MNO node 200 sends, according to the step 402, a profile generation request (e.g., an ES2+ DownloadOrder) as the download order message containing the shared profile data as input towards the SM-DP+ node 100. That is, the data included in the download order message comprises or represents the SIM profile 602.

The SM-DP+ node 100 builds the corresponding SIM profile 602 containing the received data. In the step 304, the SM-DP+ node 100 stores the generated SIM profile 602 prepared for the download for the end user 506. The SM-DP+ node 100 sends in the step 306 a profile generation response (e.g., an ES2+ DownloadOrder) as the result of the SIM profile generation with the operation result.

At receiving a successful response from the SM-DP+ node 100 in the step 404, the MNO node 200 provisions the subscriber data in the telecommunications network (e.g., to at least one of the nodes HSS, AUC, AS, etc.). Furthermore, the MNO node 200 provisions its subscriber with PIN and PUK according to the step 406.

In a third implementation, some of the shared profile data is generated by the MNO node 200 as the first data portion 604 and other data is generated in the SM-DP+ node 100 as the second data portion 606. For example, the MNO node 200 chooses the IMSI and the algorithm data. The SM-DP+ node 100 generates the key Ki as well as the PIN and the PUK, e.g., using any one of the afore-mentioned cryptographic functions. The ES2+ DownloadOrder procedure, i.e. the download order message and the SIM profile generation result exchange the shared profile data accordingly.

In any implementation, the key Ki is sensitive data for accessing the telecommunications network, so security measures are preferably taken by the RSP node 100 and the MNO node 200, e.g., for the communication through the interface 502. By way of example, the Ki is sent encrypted by a previously agreed symmetric key. Following same principles as for the exchange of Kis files, the SM-DP+ node 100 and the MNO may agree on several encryption keys. Through the ES2+ interface 502, the encrypted subscriber Ki and an indicator pointing to one of the previously agreed encryption keys is sent.

FIG. 7 schematically illustrates a first example of a signaling diagram 700 for a service flow and data exchanged, inter alia, between the SM-DP+ node 100 and the MNO node 200. In the implementation underlying the signaling diagram 700 of FIG. 7, SM-DP+ node 100 generates the shared profile data, i.e., the SIM profile 602.

The SM-DP+ node 100 and the MNO node 200 may exchange general data, which is also referred to as service metadata (e.g., at least one of a number of SIM profiles, a SIM profile type, symmetric keys such as A4-keys to encrypt the subscriber key Ki) in the initiation process. No individual subscriber data is exchanged at this point of time.

Alternatively or in addition, the initiation process may include determining which of the entities 100 and 200 is responsible for generating and/or selecting which data portion 604 and 606 of the shared profile data, i.e., the SIM profile 602. This negotiation process may be achieved using a configuration option. For example, the trigger 706 included in the download order message may comprise at least two bits. The trigger is not set if the two bits are [00]. The device-tailored SIM profile generation may be triggered if the trigger 706 is not zero (i.e., [00]). The trigger value [01] may be indicative that the first data portion 604 completely defines the SIM profile 602. The trigger value [10] may be indicative that no data input or no device-specific data is provided by the MNO node 200, so that the RSP node 100 defines the SIM profile 602. The trigger value [11] may be indicative that the SIM profile 602 is defined by the combination of the first data portion 604 and the second data portion 606.

The MNO 702 communicates through the interface 508 with an end user 506. The communication is indicative of providing the end user 506 with 3GPP service using a SIM profile 602. This communication triggers a so-called onboarding process for the end user 506.

The MNO node 200 of the MNO 702 requests (and, thus, triggers) the SM-DP+ node 100 by means of the ES2+.downloadOrder as the download order message to prepare a SIM profile 602 following a GSMA standard procedure or a modified request format, e.g., if the first data portion 604 of the shared profile data 602 is determined at the MNO 702. As pointed out above for the three exemplary implementations, the whole shared profile data 602 or the first data portion 604 (for example, the IMSI) as only a subset of the SIM profile data 602 may be sent in the step 402.

One way of realizing the any one of the implementations (e.g., the third implementation using a combination of the first data portion 604 and the second data portion 606) extends the ES2+.downloadOrder input parameters format, which is summarized in below example. An authentication management field is abbreviated by AMF. The emphasis (italic type) indicates extensions of the format.

```
{
  “type” : “object”,
  “properties” : {
    “eid” : {
      “type” : “string”,
      “pattern” : “\hat{ }[0-9]{32}$”,
      “description” : “EID as desc in SGP.02”
    },
  “iccid” : {
    “type” : “string”,
    “pattern” : “\hat{ }[0-9]{19,20}$”,
    “description” : “ICCID as desc in ITU-T E.118”
  },
  “profileType” : {
    “type” : “string”,
    “description” : “content free information defined by the Operator”
  },
  “trigger” : {
    “type”: “Boolean”,
      “description” : “True for online provisioning, false for offline
      provisioning”
  },
  “ SharedParams” : {
    “type” : “object”,
    “properties” : {
      “imsi” : {
        “type” : “string”,
        “pattern” : “\hat{ }[0-9]{14,15}$”,
        “description” : “IMSI as desc in 3GPP TS 23.003”
    },
    “EncryptedK” : {
      “type” : “string”,
      “pattern” : “\hat{ }[0-9][A-F]{32}$”,
      “description” : “Encrypted Ki for subscriber.
        Length = 128 bit for Milenage.
        Represented in Hexadecimal”
      },
    “PIN” : {
        “type” : “Number”,
        “description” : “PIN SIM number. Min = x,
          Max = x Integer value”
      },
    “PUK” : {
        “type” : “Number”,
        “description” : “PUK SIM number. Min = x,
          Max = x Integer value”
      },
        “KeyInd” : {
          “type” : “Number”,
          “description” : “Reference to key used to encrypt Ki. Min = 1,
            Max = 512 Integer value”
        },
        “FSetInd” : {
          “type” : “Number”,
          “description” : “Reference to an algorithm used for generating
            authentication vector. Min = 0, Max = 15 Integer value”
        },
        “AMF” : {
          “type” : “string”,
          “pattern” : “\hat{ }[0-9][A-F]{4}”,
          “description”: “Reference to AMF. Length = 16 bit.
            Represent in Hexadecimal.
            default = 0000”
        },
        “required” : [“imsi”, “EncryptedK”, “KeyInd”, “FSetInd”,
          “AMF”]
      }
    },
  }
}
```

In above example format specification for the first data portion 604 included in the download order message of the steps 302 and 402, the emphasized part in italic type is the extension relative to the ES2+.DownloadOrder input parameters according to GSMA SGP.22, Version 2.0, Clause 6.5.2.1.

Herein, the “trigger” variable 706 in FIG. 7 is set by the MNO node 200 to select or alternate between the “online” and “offline” provisioning to be followed by the SM-DP+ node 100. If the “trigger” 706 is set to true, the SM-DP+ node 100, proceeds to the step 304, which is absent in existing processes.

In the “SharedData” variable, the MNO node 200 sets the values defined by the first data portion 604, i.e., the portion of the shared data for generating the SIM profile 602, which the MNO node 200 determines (e.g., generates, gathers and/or chooses).

The MNO node 200 may determine all of the SIM profile 602 (e.g., according to the second implementation) or only a subset (e.g., according to the third implementation) or none (e.g., according the first implementation). In the latter case, the values for the first data portion 604 are not set, which triggers the SM-DP+ node 100 to determine (e.g., generate, gather and/or choose) the data for the SIM profile 602.

At least in the first and third implementations, the second data portion 606 is included in data 607 prepared for the MNO 702 in a step 305 of the method 300 and included in the DownloadOrder output in the step 306. The step 305 may be a substep of the step 304 or 306.

In any implementation, the trigger 706 and/or the extent of the first data portion 604 may define which entity determines and/or complements the shared profile data 602. For example, in the step 304, the SM-DP+ node 100 determines or complements the data 602 (e.g., by gathering, selection and/or generation). More specifically, depending on the trigger value 706, the SM-DP+ node 100 has two possibilities. If the trigger 706 is set to “false”, the SM-DP+ node 100 selects the data of a pre-defined eSIM profile from its storage, i.e., the inventory. This mode may establish backward compatibility.

Otherwise, if the trigger 706 is set to “true”, the SM-DP+ node 100 generates the eSIM profile data 602 “online”. That is, the SM-DP+ node 100 goes through a sequence of substeps of the step 304 for determining the second data portion 606 of the shared profile data 602, which is not provided by the MNO node 200 in the step 302. The SM-DP+ node 100 selects an IMSI from an IMSI series or from an IMSI list, if the IMSI is not received in the step 302. The SM-DP+ node 100 generate a key value, e.g., Ki, for this subscriber, if the key is not received in the step 302. The SM-DP+ node 100 generates PIN and PUK, if those are not received in the step 302.

The SM-DP+ node 100 builds the eSIM profile 602 and store it (e.g., encrypted) to be downloaded later on by the subscriber 506, i.e., to the device 504.

In the step 305 (e.g., a substep of the step 304 or 306), the SM-DP+ node 100 prepares data 607 to be sent to the MNO node 200 as the result of the SIM profile generation. The step 305 is done for the second shared profile data portion 606 determined by the SM-DP+ node 100, that is, the data portion not received from MNO node 200 in step 302.

The preparation process 305 of the data 607 includes at least one of: packaging Ki in encrypted format, so Ki is not exposed outside in clear format, using the encryption key shared with the MNO node 200; packaging PIN and PUK; and packaging supporting data so that the MNO node 200 is enabled to properly set and/or provision the telecommunications network 704. The supporting data may include an indicator for the Ki encryption (e.g., KeyIndicator or KeyInd, FsetIndicator or FsetInd, etc.)

In the step 306, the SM-DP+ node 100 sends to the MNO node 200 the ES2+ DownloadOrder output with data 607, i.e., data described by GSMA specification plus the shared profile data 602 at least to the extent determined by the SM-DP+ node 100, that is, those shared data parameters not received in the DownloadOrder input in the step 302.

An example data format for the result data 607 sent in the step 306 is summarized shown below:

```
{
“type” : “object”,
“properties” : {
  “iccid” : {
    “type” : “string”,
    “pattern” : “\hat{ }[0-9]{19,20}$”,
    “description” : “ICCID as desc in ITU-T E.118”
  },
      “SharedParams” : {
    “type” : “object”,
    “properties” : {
      “imsi” : {
        “type” : “string”,
        “pattern” : “\hat{ }[0-9]{14,15}$”,
        “description” : “IMSI as desc in 3GPP TS 23.003”
      },
      “EncryptedK” : {
        “type” : “string”,
        “pattern” : “\hat{ }[0-9][A-F]{32}$”,
        “description”: “Encrypted Ki for subscriber.
          Length = 128 bit for Milenage.
            Represented in Hexadecimal”
        },
      “PIN” : {
        “type” : “Number”,
        “description” : “PIN SIM number. Min = x,
            Max = x Integer value”
        },
      “PUK” : {
        “type” : “Number”,
        “description” : “PUK SIM number. Min = x,
            Max = x Integer value”
        },
      “KeyInd” : {
          “type” : “Number”,
          “description” : “Reference to key used to encrypt Ki. Min = 1,
              Max = 512 Integer value”
        },
      “FSetInd” : {
          “type” : “Number”,
          “description” : “Reference to an algorithm used for generating
              authentication vector. Min = 0, Max = 15 Integer value”
        },
      “AMF” : {
          “type” : “string”,
          “pattern” : “\hat{ }[0-9][A-F]{4}”,
          “description”: “Reference to AMF. Length = 16 bit.
              Represent in Hexadecimal.
              default = 0000”
        },
      “required” : [“imsi”, “EncryptedK”, “KeyInd”, “FSetInd”,
          “AMF”]
      }
    },
  }
}
```

The emphasis by italic type in above format structure is indicative of extensions relative to an existing GSMA format.

The shared data parameters, i.e., the second data portion 606, are the ones that were not present in the first data portion 604 included in the DownloadOrder input of the step 302.

Upon receiving the response, i.e., the result in the step 404 from the SM-DP+ node 100, the MNO node 200 provisions, or triggers the provisioning, of the telecommunications network 704 of the MNO 702. The network provisioning relates to both service profile and security data (e.g., involving the nodes HSS, AUC, etc.) using the data 602 contained inside the SharedParameter (which may be combined at the MNO node 200) whether determined by the MNO node 200 (or any other node in the domain of the MNO 702) or by the SM-DP+ node 100.

The network provisioning may include transferring different portions of the profile data of the SIM profile 602 by an orchestrator (e.g., the MNO node 200) of the MNO networks towards multiple entities in the MNO domain 702. The subscriber key Ki is encrypted all the way from generation to the Operators subscriber credential store (e.g., the node AUC). The orchestrator or other nodes have no knowledge about the Ki in plain-text format.

When the network provisioning is completed, the MNO node 200 sends the access data 610 (e.g., the activation code) to the subscriber 506, e.g., through the channel 508 according to the GSMA specification, to enable downloading the SIM profile 602 at the device 504. The device 504 starts a download procedure for the SIM profile 602, e.g., by means of the LPA 512 as specified by GSMA.

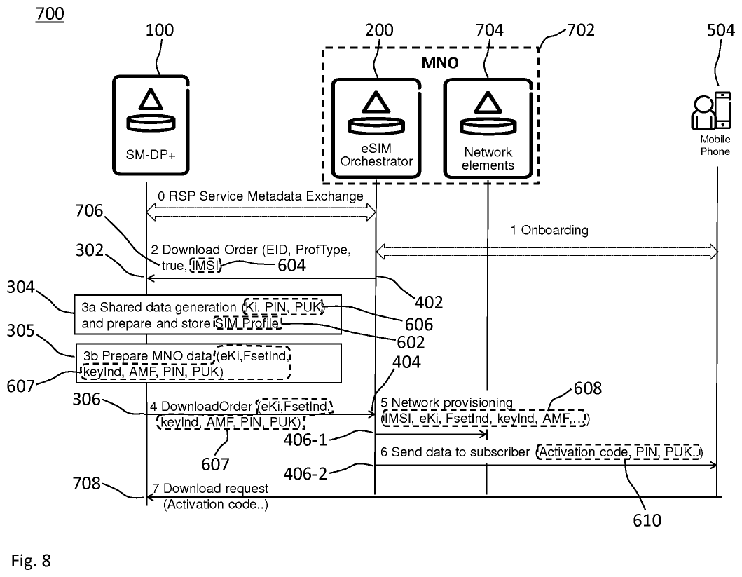

FIG. 8 schematically illustrates a second example of the signaling diagram 700, e.g., based on the third implementation. The SM-DP+ node 100 complements the eSIM profile 602. FIG. 8 shows the data flow exchange between the SM-DP+ node 100 and the MNO node 200 for the case that the eSIM profile 602 is triggered (by setting the trigger 706) to be generated “online”, wherein the MNO node 200 chooses a specific IMSI, e.g., for an IoT device 504, as the first data portion 604. The rest of the shared profile data 602, i.e. the second data portion 606, is generated by the SM-DP+ node 100.

More specifically, the SM-DP+ 100 and the MNO node 200 perform a negotiation protocol for enabling the “online” profile generation if the trigger 706 is set. The onboarding includes the MNO 702 agreeing with an end user 506 to provide the associated device 504 with 3GPP service using a SIM profile 602 to be generated and provisioned. This triggers the user onboarding process.

The MNO node 200 allocates an IMSI to the subscriber taking into account for example, the country where the user resides, the type of user or device (e.g., a mobile broadband, MBB, device). Then, the MNO node 200 requests, and thus triggers, the SM-DP+ node 100 via the ES2+.downloadOrder to generate a SIM profile by complementing the first data portion 604 already specifying the IMSI.

More specifically, the ES2+.downloadOrder comprises the values:
[eID, profileType, trigger=true, SharedData (IMSI)].

In the step 304, the SM-DP+ node 100 generates the eSIM profile 602 by gathering the SIM profile data which includes receiving the IMSI 604 from the MNO node 200 in the step 302, generating a key value (e.g., Ki) for this subscriber, and generating PIN and PUK. The SM-DP+ node 100 builds the eSIM profile 602 and store it (e.g., encrypted), which will be downloaded later on by the subscriber, i.e., by the LPA 512 to the device 504.

In the step 305, the SM-DP+ node 100 prepares the data 607 to be sent to the MNO node 200. This includes packaging Ki in encrypted format, so Ki is not exposed outside in clear format; packaging PIN and PUK; and packaging supporting data (e.g., indicator for Ki encryption, algorithm data used . . . ), so that the MNO node 200 can properly set and/or provision its telecommunications network 704.

The SM-DP+ node 200 sends the ES2+ DownloadOrder to MNO node 200 in the step 306 as the SIM profile generation result. The sent result, i.e. the ES2+ DownloadOrder, comprises:
[encrypted Ki, KeyInd, FSetInd, AMF, optionally: ICCID]

The ICCID may optionally be included or excluded in the download order message (e.g., for a resource efficient format when the trigger 706 is set). Alternatively, the ICCID may be provided in the download order message for backward compatibility.

The MNO node 200 provisions the network 704, both service profile and security data (HSS, AUC) using the data 602, i.e., HSS profile, IMSI, eKi, FsetInd, KeyInd, AMF.

In the step 406, when network provisioning completes, the MNO node 200 further sends the access data 610 (e.g., the activation code or AC) to the subscriber device 504 according to the GSMA specification to start downloading the SIM profile. The subscriber device 504 starts the SIM profile download procedure as described by GSMA.

FIG. 9 shows a schematic state diagram 900 of the SIM profile generated in the step 304. The generated SIM profile 602 is stored at the RSP node 100 for download to the device. Preferably in any implementation described herein, the generated SIM profile 602 is not stored as one of many available and yet unused SIM profiles in an inventory. Rather, the state 902 of the generated SIM profile 602 allows for download of the generated SIM profile 602, optionally after the MNO node 200 has indicated that network provisioning has been completed. This state 902 corresponds to a state outside of the availability state 904 associated with SIM profiles stored in the inventory.

By not storing a large number of SIM profiles in a central node such as the RSP node 100 and/or by avoiding the “available” state 902, an implementation of the technique may be more secure, for example because security-relevant data is created on-demand, shared on the fly (i.e., as it is generated) and/or provisioned compared to a (e.g., long-term) accumulation of (e.g., a larger number of) security-critical information.

By way of example, the SIM profile 602 in the SM-DP+ node 100 may be in an initial state of “not existing” (such as “not yet existing” or “not yet complete”), e.g., as long as the first data portion 604 is not yet received from the MNO node 200. In contrast, conventionally prepared batches of SIM profiles or SIM profiles that are not device-specifically generated may be in the state 904 of being “Available”.

After the step 302, i.e. after receiving the “DownloadOrder”, the SIM profile is “Linked” or “Allocated” (e.g., if not tailored for the EID). Preferably, the “available” state 902 is not needed. The SIM profile 602 is completely generated and linked and/or allocated after the step 302 (i.e., the “DownloadOrder”).

From the states “Linked” or “Allocated”, the flow in the state diagram 900 may follow the existing standard, e.g., according to GSMA SGP.22. More specifically, after sending a “ConfirmOrder” from the MNO node 200, the SIM profile 602 is in a “confirmed” state or “released”. After the function “GetboundProfile” has been executed in communication with the device, the SIM profile 602 enters the state “downloaded”.

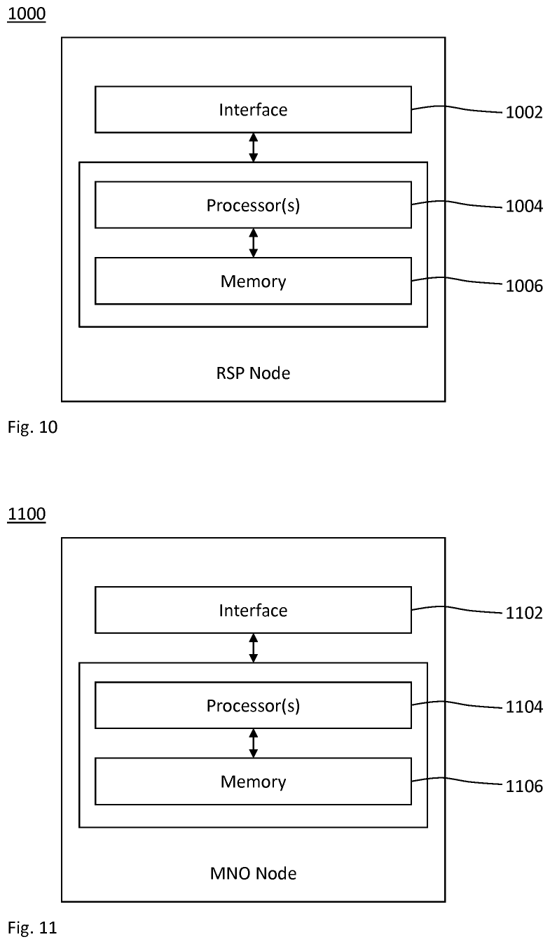

FIG. 10 shows a schematic block diagram for an embodiment of an RSP node 1000. The RSP node 1000 comprises one or more processors 1004 for performing the method 300 and memory 1006 coupled to the one or more processors 1004. For example, the memory 1006 may be encoded with instructions that implement at least one of the modules 102, 104 and 106. An interface 1002 may be operative to provide the functionality of the interface 502.

The one or more processors 1004 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide RSP functionality, either alone or in conjunction with other components of the RSP node 1000, such as the memory 1006. For example, the one or more processors 1004 may execute instructions stored in the memory 1006. Such functionality may include providing various features and steps discussed herein, including any of the benefits disclosed herein. The expression “being operative to perform an action” may denote the RSP node 1000 being configured to perform the action.

FIG. 11 shows a schematic block diagram for an embodiment of an MNO node 1100. The MNO node 1100 comprises one or more processors 1104 for performing the method 400 and memory 1106 coupled to the one or more processors 1104. For example, the memory 1106 may be encoded with instructions that implement at least one of the modules 202, 204 and 206. An interface 1102 may be operative to provide the functionality of the interface 502.

The one or more processors 1104 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide MNO functionality, either alone or in conjunction with other components of the MNO node 1100, such as the memory 1106. For example, the one or more processors 1104 may execute instructions stored in the memory 1106. Such functionality may include providing various features and steps discussed herein, including any of the benefits disclosed herein. The expression “being operative to perform an action” may denote the MNO node 1100 being configured to perform the action.

In any embodiment, the interface 502 (e.g., the ES2+ interface) may comprise network nodes and/or network links connecting the RSP node 100 and the MNO node 200. Alternatively or in addition, in any embodiment, an instance of the interface 502 (e.g., the ES2+ interface) may be implemented at each of the RSP node 100 and the MNO node 200.

FIG. 12 schematically illustrated a block diagram for an exemplary implementation of the interface 502.

In the exemplary implementation of FIG. 12, an instance of the interface 502 is implemented at each of the RSP node 100 and the MNO node 200. The instance of the interface 502 at the RSP node 100 comprises at least one of an interface module 108 and a physical interface 1002. The instance of the interface 502 at the MNO node 200 comprises at least one of an interface module 208 and a physical interface 1102.

Each of the interface modules 108 and 208 is configured to provide a set of functions to the nodes 100 and 200, respectively. The set of functions may comprise at least one of Request-Response Functions and Notification Handler Functions, e.g., according to the GSMA document SGP.02, “Remote Provisioning Architecture for Embedded UICC Technical Specification”, Version 3.2, Tables 96 and 97, respectively. Alternatively or in addition, each of the interface modules 108 and 208 is configured to map the interface functions to messages (e.g., to remotely trigger one or more of the interface functions by sending the one or more messages resulting from the mapping) and/or to map received messages to the interface functions (e.g., to locally trigger one or more of the interface functions resulting from the mapping). The messages may be transported between the sender and the receiver (e.g., being the MNO node 200 and the RSP node 100 in the steps 302 and 402, and vice versa in the steps 306 and 404), e.g., according to the GSMA document SGP.02, Annexes A and B. The mapping may be implemented at an application layer (or layer 7) of a protocol stack at the respective nodes 100 and 200.

In a connected state of the interface 502, i.e. if the peer instances of the interface 502 are mutually connected, the messages may be transported (and thus the data may be shared) in a session 1200 and/or through a protected tunnel. The instances of the interfaces 502 may be connected via the Internet. For transporting the messages, each interface module 108 and 208 may implement an existing Internet protocol (e.g., on a session layer or layer 5) such as Transport Layer Security (TLS) and/or Hypertext Transfer Protocol Secure (HTTPS), e.g., according to the GSMA document SGP.02, Annex B.2.2.

Herein, the expression “interface” 502 may refer to any one of the instances of the interface 502 at the nodes 100 and 200 and/or the session 1200 established between the nodes 100 and 200.

As has become apparent from above description, embodiments of the technique can overcome the drawbacks a conventional offline batch process that preemptively shares a plurality of SIM profiles between the RSP node and the MNO. The technique can be embodied by enhancing RSP for exchanging the shared profile data over the ES2+ interface when the specific SIM profile is necessary, i.e., responsive to an profile-individual trigger determined at the MNO. For example, a subscriber can maintain its PIN. Furthermore, the MNO can reduce the rate of updating network access credentials, thus reducing the load on a backhaul network.

SIM profile generation and tailoring can be integrated in the download order. Since, in the moment of issuing the download order, the MNO knows the device that the subscriber is going to use for downloading the SIM profile to be generated, the profile can be linked and/or tailored to the device already at the time of SIM profile generation. Moreover, the tailoring can respond to certain circumstances such type or current usage of the device, e.g., being or being used as a tablet, a smartphone or a camera. The MNO may have, for example, different IMSI series for different devices, e.g., matched to Quality of Service requirements of the radio communication services of the device. For example, cameras or refrigerators may have lower requirements (e.g., in terms of reliability or latency) as compared to tablets (which communication services may be important) or for smartphones (which communication services may be the most important).

The technique may be implemented by enhancing the interface specification between MNO and SM-DP+ node. The SM-DP+ node and the MNO can share IMSI, Ki, PIN and PUK data at the time a profile is ordered for a subscriber. The SIM profile can be dynamically provisioned to both the telecommunications network and the device (i.e., the eUICC), e.g., at the same time. The technique can eliminate the need for a complex data synchronization process required beforehand for existing network provisioning processes.

A first data portion corresponding to the SIM profile can be provided to the SM-DP+ node, which enables download provisioning of the specific SIM profile. A second data portion corresponding to the SIM profile provided to the MNO node enables provisioning of the associated telecommunications network. This allows the MNO to trigger a procedure in the SM-DP+ node to generate the eSIM profile online, i.e., in individual causal correlation with the SIM profile allocation triggered by the MNO. For example, the MNO node can order the individual SIM profile generation for a specific IMSI according with its IMSI allocation policy.

Furthermore, the technique can permit changing an already existing subscription. The MNO can, for example, trigger generation and download provisioning of a SIM profile, e.g., with same IMSI, ICCID and/or profile data but with a different key Ki. Such a change of an existing subscription may be triggered for the same device if any security threads are detected, or for another device of the same user if the device has been stolen or lost.

Same or further embodiments can eliminate the need for an additional process between MNO and SM-DP+ node for sharing batches of SIM profiles, and/or can eliminate the need of maintaining a dedicated interface for such sharing such batches. Particularly, there is no need for an out-of-band exchange of encrypted files and for exchanging references to previously generated and shared profiles.

By eliminating the preemptive (i.e., prior to download) generation of a plurality of SIM profiles, back-end pre-provisioning processes can be reduced to a minimum. Furthermore, by sharing the subscriber data (e.g., IMSI, Ki, etc.) online, i.e., at profile order time, the corresponding SIM profile is readily used (i.e., downloaded). This ensures dynamicity in the SIM provision process and optimizes usage of network resource. Particularly, IMSI allocation can be handled by the MNO and IMSI reusability can be improved.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

1-37. (canceled)

38. A method of operating a Remote Subscriber Identity Module (SIM) Provisioning (RSP) node which is configured for RSP; the RSP node comprising or connectable to an interface for communication with an Mobile Network Operator (MNO) node of an MNO; the method comprising:
receiving a download order message from the MNO node through the interface, the download order message including data for generating a SIM profile;
generating the SIM profile in response to the download order message according to the data received for generating the SIM profile; and
sending a result of the SIM profile generation through the interface to the MNO node.

39. The method of claim 38, wherein the data received in the download order message is included in or input to the generated SIM profile.

40. The method of claim 38, wherein the data included in the download order message defines the SIM profile.

41. The method of claim 38, wherein the data included in the download order message defines a first data portion of the SIM profile.

42. The method of claim 41, wherein the generating the SIM profile comprises complementing the received first data portion with a second data portion, wherein the combination of the first data portion and the second data portion defines the SIM profile.

43. The method of claim 42, wherein the generating the SIM profile includes the RSP node combining the first data portion and the second data portion.

44. The method of claim 42, wherein the sent result of generating the SIM profile includes the second data portion.

45. The method of claim 42, wherein the data received in the download order message, the first data portion, and/or the second data portion includes configuration data for network provisioning, operator credentials, and/or subscriber credentials.

46. The method of claim 42, wherein the data received in the download order message, the first data portion, and/or the second data portion includes an international mobile subscriber identity (IMSI), network access credentials, authentication algorithm parameters, a personal identification number (PIN), and/or a personal unlocking key (PUK).

47. The method of claim 42, wherein the data in the download order message, the first data portion, and/or the second data portion exchanged between the RSP node and the MNO node through the interface is encrypted using a symmetric key previously shared between the RSP node and the MNO node.

48. The method of claim 47:
wherein a plurality of symmetric keys is previously shared between the RSP node and the MNO node; and
wherein the exchange between the RSP node and the MNO node through the interface includes an indicator referring to one of the shared symmetric keys.

49. The method of claim 48, wherein a different one of the shared symmetric keys is used when generating different SIM profiles.

50. The method of claim 38:
wherein the download order message includes a trigger; and
wherein the SIM profile is selectively generated in response to the download order message according to the data if the trigger is set.

51. The method of claim 38, wherein a single SIM profile is generated in response to the download order message.

52. The method of claim 38, wherein, upon sending the result of the SIM profile generation, the generated SIM profile is in an allocated state, a linked state, a confirmed state, or a released state.

53. The method of claim 38, wherein generating the SIM profile includes providing the SIM profile for download.

54. The method of claim 38, wherein the generating the SIM profile comprises building a protected profile package (PPP) including the SIM profile.

55. The method of claim 38, wherein the sending the result of the generation comprises sharing the generated SIM profile with the MNO.

56. The method of claim 38, wherein the RSP node includes functionality for Subscription Manager Data Preparation (SM-DP).

57. The method of claim 38, wherein the interface includes an ES2 interface.

58. A method of operating an Mobile Network Operator (MNO) node of an MNO, the MNO node configured to trigger Remote Subscriber Identity Module (SIM) Provisioning (RSP); where the MNO comprises or is connectable to an interface for communication with an RSP node configured for RSP, the method comprising:
sending a download order message to the RSP node through the interface, the download order message including data for generating a SIM profile;
receiving, through the interface and from the RSP node, a result on the SIM profile generated in response to the download order message according to the data sent for generating the SIM profile; and
provisioning, based on the received result of the SIM profile generation, a telecommunications network of the MNO and/or a device radio-connectable with the telecommunications network.

59. The method of claim 58, wherein the download order message includes a trigger for causing, at the RSP node, the SIM profile to be selectively generated in response to the download order message according to the data if the trigger is set.

60. A non-transitory computer readable recording medium storing a computer program product for controlling a Remote Subscriber Identity Module (SIM) Provisioning (RSP) node which is configured for RSP; the RSP node having or connectable to an interface for communication with a Mobile Network Operator (MNO) node of an MNO; the computer program product comprising program instructions which, when run on processing circuitry of the RSP node, causes the RSP node to:
receive a download order message from the MNO node through the interface, the download order message including data for generating a SIM profile;
generate the SIM profile in response to the download order message according to the data received for generating the SIM profile; and
send a result of the SIM profile generation through the interface to the MNO node.

61. A non-transitory computer readable recording medium storing a computer program product for controlling a Mobile Network Operator (MNO) node of an MNO, the MNO node configured to trigger Remote Subscriber Identity Module (SIM) Provisioning (RSP); the MNO node having or connectable to an interface for communication with an RSP node configured for RSP; the computer program product comprising program instructions which, when run on processing circuitry of the MNO node, causes the MNO node to:
send a download order message to the RSP node through the interface, the download order message including data for generating a SIM profile;
receive, through the interface and from the RSP node, a result on the SIM profile generated in response to the download order message according to the data sent for generating the SIM profile; and
provision, based on the received result of the SIM profile generation, a telecommunications network of the MNO and/or a device radio-connectable with the telecommunications network.

62. An Remote Subscriber Identity Module (SIM) Provisioning (RSP) node configured for RSP; the RSP node having or connectable to an interface for communication with a Mobile Network Operator (MNO) node of an MNO; the RSP node comprising:
processing circuitry;
memory containing instructions executable by the processing circuitry whereby the RSP node is operative to:
receive a download order message from the MNO node through the interface, the download order message including data for generating a SIM profile;
generate the SIM profile in response to the download order message according to the data received for generating the SIM profile; and
send a result of the SIM profile generation through the interface to the MNO node.

63. A Mobile Network Operator (MNO) node of an MNO; the MNO node configured to trigger Remote Subscriber Identity Module (SIM) Provisioning (RSP); the MNO node having or connectable to an interface for communication with an RSP node configured for RSP; the MNO node comprising
processing circuitry;
memory containing instructions executable by the processing circuitry whereby the MNO node is operative to:
send a download order message to the RSP node through the interface, the download order message including data for generating a SIM profile;
receive, through the interface from the RSP node, a result on the SIM profile generated in response to the download order message according to the data sent for generating the SIM profile; and
provision, based on the received result of the SIM profile generation, a telecommunications network of the MNO and/or a device radio-connectable with the telecommunications network.
